(19) United States
(12) Patent Application Publication
(10) Pub. No.: US 2017/0334006 A1
(43) Pub. Date: Nov. 23, 2017

(54) CUTTING TOOL AND MECHANISM THEREFOR

(71) Applicant: Arbortech Industries Limited, Perth (AU)

(72) Inventor: Kevin Ross Inkster, Perth (AU)

(21) Appl. No.: 15/504,092

(22) PCT Filed: Aug. 14, 2015
(86) PCT No.: PCT/AU2015/050465

§ 371 Date: Feb. 15, 2017

(30) Foreign Application Priority Data
Aug. 15, 2014 (AU) 2014903193

(51) Int. Cl. B23D 57/00; B27B 19/00; B23D 61/18; B28D 1/06; B23D 61/00

(52) U.S. Cl. CPC B23D 57/00; B28D 1/068; B23D 61/006; B23D 61/18; B27B 19/008

(57) ABSTRACT

A cutting tool mechanism and cutting tool (11) including the mechanism (31), for cutting hard material such as concrete and stone is disclosed. The tool (11) has one or two blades (23), (25) each driven by a mechanism (31). Each mechanism (31) has an input coupling 35 for transmission of rotary motion from a motor, and an output coupling (141), (143) to transmit resultant orbital, oscillatory or impact motion to the blade (23), (25). A suspension or sliding coupling located between the output coupling (141), (143) and the blade (23), (25), is provided, through which motion to the blades is transmitted. The suspension or sliding coupling absorbs impacts of the blades with the material being cut, rendering the tool more controllable.

### TECHNICAL FIELD

This invention relates to tools for cutting, and in particular to a mechanism for use in tools for cutting.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

This invention relates to a cutting apparatus and in particular without limiting the invention, to a cutting apparatus where one or more blades are caused to move in an orbit. Typically, each such blade moves in an orbit having a plane which lies substantially in the same plane as the plane of the blade. With this arrangement the blade will cut typically on a part of the orbit where the blade is urged toward the workpiece.

This invention is applicable to tools having one such blade, and also to tools having two juxtaposed blades are caused to move sequentially with teeth following orbital paths. The tools in which this invention is applicable are those described by the inventor in U.S. Pat. No. 5,456,011 filed Oct. 12, 1993, U.S. patent application Ser. No. 12/744,147 filed Nov. 24, 2008, and U.S. patent application Ser. No. 13/501,455 filed Oct. 12, 2010, the contents of all of which are incorporated by cross-reference. The tools of this type have two blades mounted juxtaposed, that is side by side, close together if not touching each other, and the blades orbits move 180° out of phase relative to each other.

The orbital paths may be elliptical, which is the case with the cutting tools disclosed in the above described patent cases.

The products described in these patent specifications have been marketed by the applicant under the trade mark “Allsaw”. These products have a pair of blades arranged side by side and driven by a cam mechanism mounted roughly in the centre of a con rod/blade assembly. A pivot point at the top of the con rod is restrained in one plane while the cam rotates in a circular orbit. The teeth of the blade being mounted roughly equidistant and opposite to the pivot point from the cam so that when the cam scribes a circular orbit, the teeth follow an elliptical orbit.

The above described cutting tools are effective in cutting soft to medium material such as some brick and mortar, but their efficiency rapidly deteriorates if they encounter hard mortar or hard bricks. As the hardness of material being cut increases, it also increases the reaction of the cutting tool to the user, such that with very hard mortar or bricks it begins to bounce, rendering it impractical to use. With very hard material such as concrete or hard rock, the carbide teeth used along the cutting edge of the blade are also prone to breaking off.

It is an object of the invention to provide an arrangement for a cutting tool that can overcome the abovementioned problem.

Throughout the specification unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with one aspect of the invention there is provided a cutting tool mechanism for a cutting tool having a blade; in said cutting tool, said blade being driven by a driving mechanism with an input coupling for transmission of rotary motion from a motor, and an output coupling to transmit resultant orbital, oscillatory or impact motion to said blade, wherein said cutting tool mechanism comprises located between said output coupling and said blade, a coupling selected from a slide coupling and/or a spring suspension coupling through which the motion of said output coupling is transmitted to said blade.

In accordance with a second aspect of the invention there is provided a cutting tool having a blade driven by a driving mechanism with an input coupling for transmission of rotary motion from a motor, and an output coupling to transmit resultant orbital, oscillatory or impact motion to said blade, wherein a coupling selected from a slide coupling and/or a spring suspension coupling is located between said output coupling and said blade, through which the motion of said output coupling is transmitted to said blade.

Preferably, said coupling has travel extending toward said blade.

Preferably, said coupling has linear travel extending toward said blade.

Preferably, said coupling has linear travel extending substantially in the same direction of the intended cut into the workpiece. This would typically be transverse to the surface of the workpiece, assuming a flat workpiece surface. In this manner, the coupling acts to set up a resonance between the output coupling and the blade, which has been found unexpectedly to enhance the cutting action.

Preferably the coupling includes a dampener to dampen movement along its travel.

Preferably the coupling is biased to a position along its travel.

Preferably, said coupling is a spring biased sliding coupling.

In one arrangement the coupling may have a unidirectional bias, to urge the blade toward the workpiece, so that the coupling absorbs jarring impact forces from the blade; however, in the most preferred form the coupling has a bidirectional bias, so that the coupling suspends the blade from the output coupling.

A coupling with a unidirectional bias may use a single compression coil spring to bias the blade toward the cut and provide some shock absorbing. With a unidirectional bias it may require a resilient buffer located between parts at the extremes of travel of said coupling, in order to absorb impact forces to increase the life of the components in the coupling, if not to minimise noise.

A coupling with a bidirectional bias may use a single compression coil spring or two compression springs to bias the blade to a central position along the extent of travel of the spring suspension coupling. This arrangement urges the blade of the cutting tool toward the cut, and provides some shock absorbing, and also stores and releases energy where resistance encountered by the blade is overcome, and also assists to avoid the coupling slamming to the end of its travel.

Alternatively, the coupling with a bidirectional bias may use a flat spring which undergoes flexure when subject to deflection from the central position.

However in the most preferred arrangement, the coupling uses at least one flat spring to suspend said blade from said output coupling toward a central position along the extent of travel of the coupling. The output coupling operates in a reciprocating manner, and the blade may bounce, suspended by the flat spring(s).

Preferably the orbital, oscillatory or impact motion of the blade is elliptical with its long axis extending substantially in the direction that the cutting edge or teeth of the blade extend, and the travel of the coupling extending linearly in a direction extending across the long axis.

Preferably the orbital, oscillatory or impact motion of the blade is elliptical with its short axis extending substantially in the direction of the linear travel of the coupling.

In either arrangement of unidirectional bias or bidirectional bias, preferably the maximum extent of travel in the coupling is less than the oscillatory excursion of the output coupling in the same direction of travel as the coupling.

Preferably the compression spring strength is selected so that at maximum no-load operating speed of the cutting tool, when the compression spring is under compression, the coupling will not reach the end of its travel.

Alternatively the compression spring strength is selected so that at maximum no-load operating speed of the cutting tool, when the compression spring is under compression, the coupling will just reach the end of its travel, but not impact with the end of its travel.

As a further alternative, preferably the compression spring strength is selected so that at maximum no-load operating speed of the cutting tool, when the compression spring is under compression, the coupling will reach the end of its travel, and resilient compressible buffers are provided in said coupling to absorb any impact forces imparted at the end of the travel.

In practice the selected spring strength is determined by a number of factors. For maximum efficiency and effectiveness of the cutting tool, the springs should compress to the maximum extent at no load full operational speed. Due to various factors such as variation in maximum motor speed between motors, and the effect of blades having different weights, it may be desirable to allow the coupling to reach the end of its travel at maximum no-load operating speed of the cutting tool, in which case resiliently flexible stops should be incorporated into the couplings in order to prevent premature failure.

Preferably the blade is mounted to a mounting portion extending from one end of the coupling, and the other end of the coupling extends to a pivot point to restrain movement from the output coupling.

Preferably the pivot point is provided by a resilient mount that allows motion in the substantial direction extending between the output coupling and the pivot point, while restraining motion in any other direction. The resilient mount may be formed by a strip of spring steel or the like that is flexible in the direction of movement of the coupling, but resists movement in other directions, and is inextendable under tension or compression.

Preferably the output coupling transmits a circular orbital motion to said coupling. The effect of the above described pivot action is to translate the circular orbital motion to an elongated elliptical motion at any point of the blade. The mechanism between the input coupling and the output coupling that achieves this is a crankshaft having its output coupling axis offset from the input coupling axis.

Preferably said coupling comprises said output coupling mounted for linear travel relative to a body, said output coupling being biased by at least one spring, and having a bearing for connecting to said crankshaft.

Preferably said coupling comprises said output coupling contained within a housing in said body, mounted for linear travel, and being biased by at least one spring member, and having a bearing for connecting to said crankshaft.

Preferably said output coupling is mounted for linear travel relative to said body on a bearing surface.

Preferably said bearing surface comprises a journal surface machined into said output coupling.

Preferably said linear travel bearing surface is provided by at least one aperture extending through said output coupling, each aperture co-operating with a pin which is secured to said mounting portion.

Preferably said output coupling is biased by a said spring located at each end to suspend said output coupling relative to said body, for substantially linear travel.

Any or each said at least one spring may comprise a flat spring which undergoes flexure when subject to deflection from its rest position. The flat spring may allow linear or arcuate movement but linear movement is preferred.

However in the most preferred arrangement, the coupling uses at least one flat spring to suspend said body (and hence said blade) from said output coupling. Preferably said at least one flat spring comprises a pair of springs. The pair of flat springs may be configured to restrain said coupling for linear or arcuate movement, but it is preferred that they restrain said coupling for linear movement, rather than arcuate movement.

Preferably body comprises a housing and said output coupling is suspended within said housing by a pair of flat springs.

Preferably said coupling comprises two flat springs, one located near or at opposite ends of said output coupling. Preferably these flat springs extend across the extent of travel of the output coupling, most preferably normal thereto.

Preferably the flat springs are secured at three locations therealong, being toward either end to secure to said body and being centrally located to secure to said output coupling. There may be securing apertures or a single aperture provided at each of the three locations.

Preferably the three locations are located substantially in-line.

While the springs are flat, preferably the flat springs have a flat body that between adjacent locations, deviates away from the line intersecting the three locations. This allows a component of torsion in the flat springs to be introduced through movement in the coupling. In addition, due to the two locations toward either end where the flat spring is secured to the body being fixed relative to each other, movement of the coupling will also place the flat springs under tension through the curvature in their body between adjacent apertures.

The flat springs may be visualised as being shaped approximately in a W or E or 3 shape with three apertures in-line located approximately near the end of each leg, at the three locations. W or E shaped configurations are not so preferred since the spring can fracture at the sharp corners.

Preferably between adjacent locations, the flat body deviates away from the line intersecting the three locations in a smoothly curving configuration. This smoothly curving structure avoids stresses that can occur at sharp corners.

By way of explanation, in a most preferred embodiment, the input coupling is a crankshaft which is driven by a rotary motor, the output coupling is a cam follower which does not rotate, but moves to and fro, and the body is suspended relative to the output coupling by spring members. The output coupling and the body together form a spring suspension coupling. A blade is attached depending from the body at one end of the spring suspension coupling. The body is restrained from rotating with the input coupling by the spring members and by a pivot point mount located opposed from the blade, depending from the body at the other end of the spring suspension coupling. As a result of the provision of the pivot point, the output coupling prescribes an elliptical path, and this movement is exaggerated at the blade cutting edge, which is located further from the pivot point. The location of ends of the spring suspension coupling, is determined by reference to the major direction of reciprocating motion, by the spring suspension coupling as restrained by the pivot point. The blade is preferably attached to the body at said one end by a mounting portion, which may include fasteners allowing quick release of the blade.

Preferably said resiliently flexible stops are provided by o-rings fitted on said pin or pins, located between said component and said mounting portion. The o-rings are compressed axially between the component and mounting portion, should the component reach the end of its linear travel within the mounting portion.

Preferably said driving mechanism has said input coupling for transmission of rotary motion from a motor, and said driving mechanism has a first said output coupling to transmit resultant orbital, oscillatory or impact motion to a first blade, wherein said cutting tool mechanism includes located between said first output coupling and said first blade, a first said coupling through which the motion of said output coupling is transmitted to said blade, and said driving mechanism has a second said output coupling to transmit resultant orbital, oscillatory or impact motion to a second blade, wherein said cutting tool mechanism includes located between said second output coupling and said second blade a second coupling through which the motion of said second output coupling is transmitted to said second blade.

Preferably the first output coupling and the second output coupling are mounted about axes located opposite the axis of the input coupling.

Also in accordance with the present invention, there is provided a cutting tool incorporating two cutting tool mechanisms as described above, located side by side, wherein the input couplings of both said mechanisms comprise a common crankshaft having journals each connected for rotation with a cam follower to form the output coupling of each said cutting tool mechanism, where the journals of said crankshaft are out of phase.

Preferably the journals of said crankshaft are 180° out of phase.

While the coupling is described as a spring suspension coupling or a sliding coupling or a combination of both, in effect the coupling is a guided coupling which allows to and fro give between the output coupling and the blade, into the cut being made. Where in one embodiment, the flat springs guide the movement of the blade relative to the output coupling of the tool, in an alternative embodiment, as will be seen, the coupling has bearing surfaces to guide the movement of the blade relative to the output coupling of the tool. In such a coupling, coil springs provide the suspension, but not the guiding function. In a further embodiment, providing that there is some sort of slide coupling arrangement to provide the guidance, the springs could be dispensed with or replaced with rubber or other compressible material.

### BRIEF DESCRIPTION OF DRAWINGS

Three preferred embodiments of the invention will now be described in the following description of power saws for cutting concrete, brick and the like, made with reference to the drawings in which:

FIG. 1 is a perspective view of an electrically operated hand held power saw according to the first embodiment;

FIG. 2 is an opposite side perspective view of the electrically operated power saw of FIG. 1 showing drive to the input coupling;

FIGS. 3 to 6 are side elevations showing the motion sequence of a blade and associated driving mechanism and spring suspension coupling;

FIG. 7 is a perspective view of a pair of blades of the power saw with their associated spring suspension couplings and driving mechanism;

FIG. 8 is a part exploded view of the parts shown in FIG. 7;

FIG. 9 is a view showing the path traced by the blade in the embodiment operating under no load at low speed;

FIG. 10 is a view showing the path traced by the blade in the embodiment operating under no load at high speed;

FIG. 11 is a view showing the path traced by the blade in the embodiment operating under load at high speed;

FIG. 12 is a perspective view of a plunge cut blade of a power saw of the second embodiment, with its associated spring suspension coupling and driving mechanism;

FIGS. 13 to 16 are a side view of showing the mechanism of an electrically operated power saw according to the third and most preferred embodiment;

FIG. 17 is a perspective view of the mechanism of FIGS. 13 to 16; and

FIG. 18 is an exploded perspective view of the mechanism of FIG. 17; and

FIG. 19 is a plan view of the flat springs used in the third embodiment.

### DESCRIPTION OF EMBODIMENTS

The cutting tool 11 according to the first embodiment has a body 13 housing an electric motor, a handgrip portion 15 at the rear of the body 13 incorporating a control switch 17 with or without variable speed control for controlling the electric motor, a transmission case 19 at the front of the body 13, a hand grip 21 atop the transmission case 19, and a pair of blades 23 and 25 arranged side by side, extending from underneath the transmission case 19. Whether the switch 17 incorporates a variable speed controller depends on the application of the tool. For most concrete cutting operations a constant speed is sufficient

The transmission case 19 houses a bevel reduction-gear assembly to translate the axis of rotary motion of the electric motor, and a reduction belt drive 27 leading to a large pulley 29, together the bevel reduction-gear assembly and reduction belt drive 27 reduce the angular velocity of the electric motor (and multiply the torque). The reduction belt drive 27 and associated pulleys can be toothed, in order to prevent slippage, but a v-belt without toothed pulleys can be advantageous in applications where the blades might jam, in which circumstances the reduction drive belt would double as a clutch mechanism.

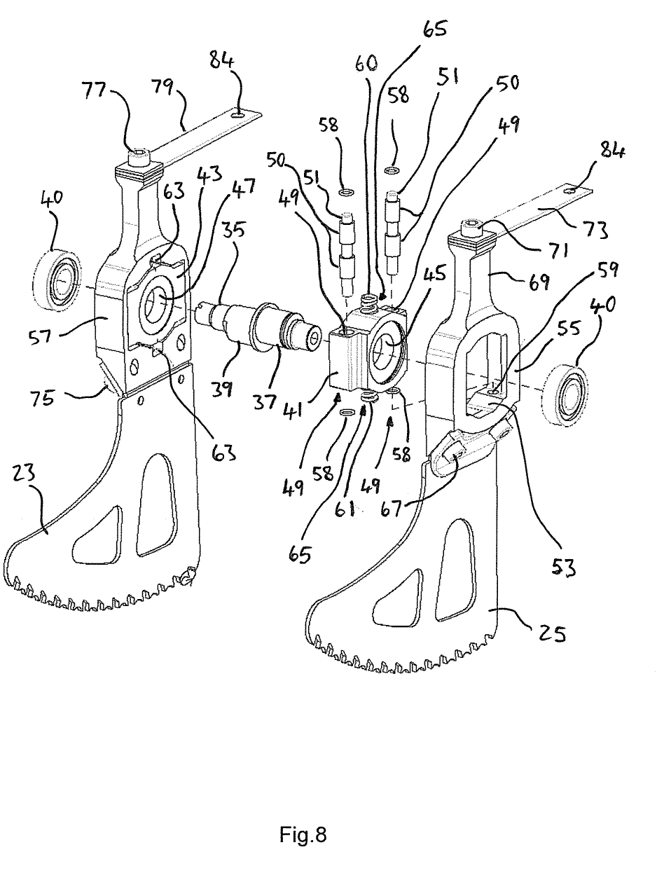

The large pulley 29 is directly connected to the driving mechanism 31 of the cutting tool 11, in effect forming part of the input coupling 33. The driving mechanism 31 has a crankshaft 35 having two journals 37 and 39 off-set from the central axis of the crankshaft by about 2 mm, and offset from each other by 180° relative to the central axis of the crankshaft 35. The crankshaft 35 is supported for rotation on roller bearings 40 see FIG. 8).

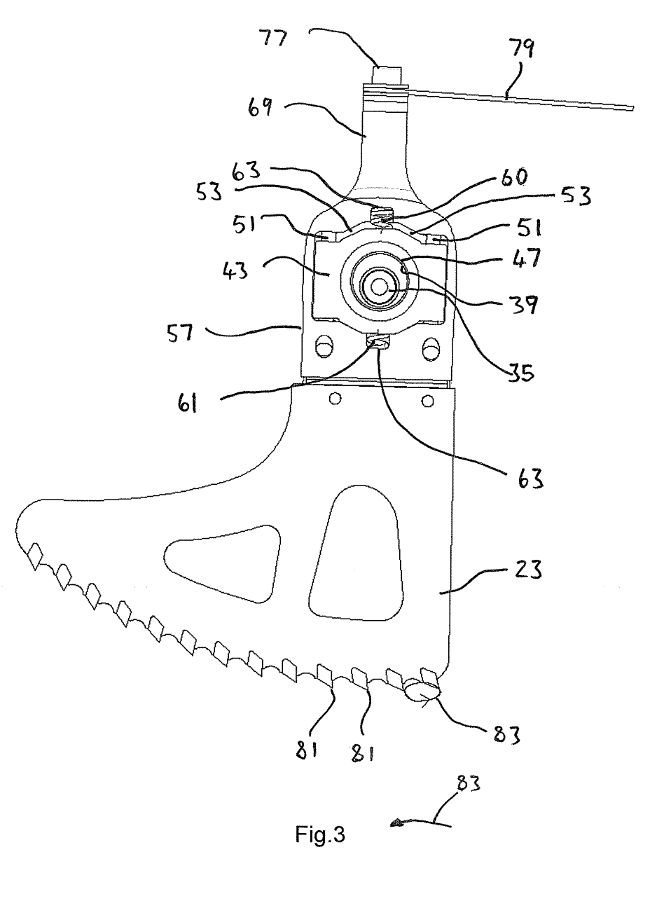

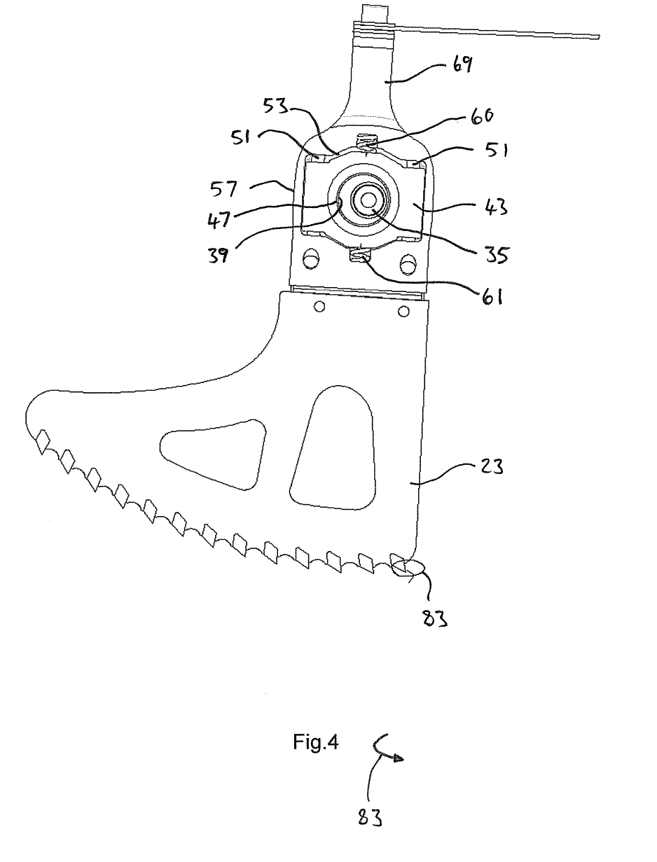

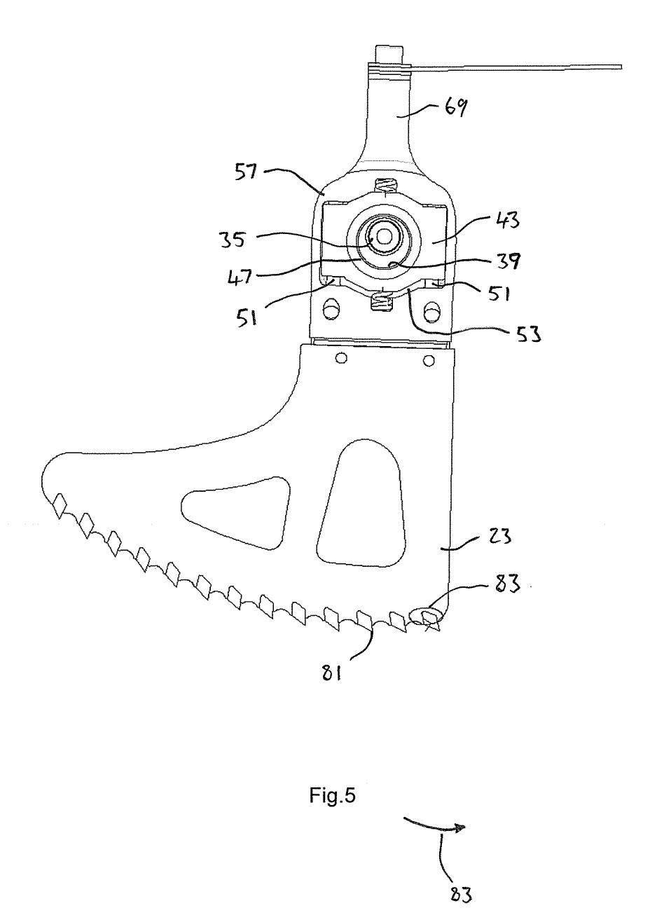

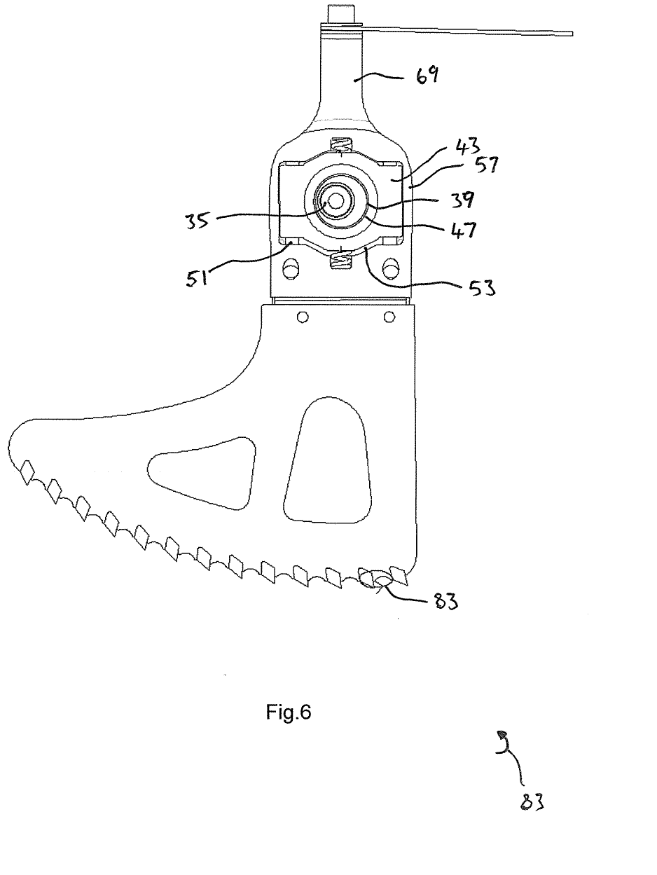

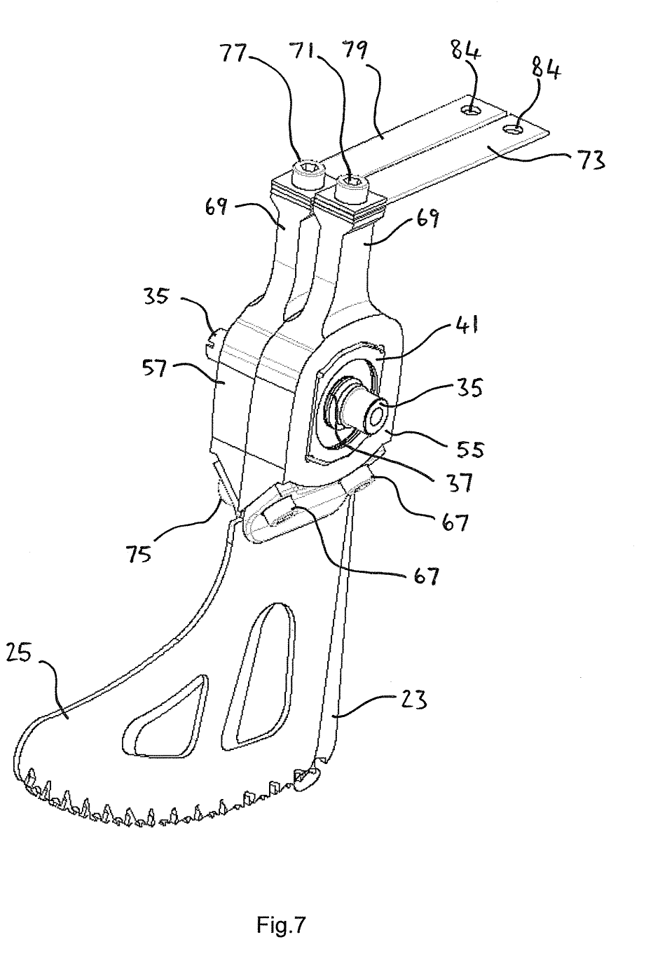

The driving mechanism 31 has two output couplings formed by components in the cam followers 41 and 43 having cylindrical bearing surfaces 45 and 47 respectively that co-operate with journals 37 and 39 respectively (see FIGS. 7 and 8). It should be noted that in the part views shown in FIGS. 3 to 6, the journal 37 has been omitted from the end view of the crankshaft 35, while the end of the crankshaft 35 is shown to provide a reference point for journal 39 in the motion sequence illustrated in FIGS. 3 to 6. The cam followers 41 and 43 each have linear travel bearing surfaces formed by apertures 49 extending through the cam followers that mate for sliding movement with bearing surfaces 50 on pins 51 that when assembled each extend through an aperture 49, and contained within a housing 53, each located in mounting portions in the form of connecting rod 55 and 57.

The housing 53 in connecting rod 55 contains cam follower 41 for sliding vertical movement, and the housing 53 in connecting rod 57 contains cam follower 43 for sliding vertical movement. The pins 51 each receive resiliently flexible stops in the form of o-rings 58 over the exposed ends of the pins 51 connecting rods 55 and 57, the o-rings 58 locating between the cam followers 41, 43 and the connecting rods 55, 57 respectively, to prevent metal to metal contact at the ends of the travel of the connecting rods 55, 57. The pins 51 are received in bushes 59 press-fit into the connecting rods 55 and 57, at the top and bottom of the housing 53.

Cam follower 41 is biased to a central position within the housing 53 in connecting rod 55 by an upper spring 60 and a lower spring 61 received in recesses 63 in the connecting rod 55 and circular recesses 65 in the cam follower 41. Similarly cam follower 43 is biased to a central position within the housing 53 in connecting rod 57 by an upper spring 60 and a lower spring 61 received in recesses 63 in the connecting rod 55 and circular recesses 65 in the cam follower 41. The assemblies of cam follower 41 and connecting rod 55 on the one hand and cam follower 43 and connecting rod 57 on the other hand, are mirror images of each other, but are otherwise identical.

The assembly of cam follower 41 co-operating with journal 37 forms one output coupling, while the assembly of cam follower 43 co-operating with journal 39 forms another output coupling.

The connecting rod 55 has a bevelled portion on its outside, below the housing 53, to which blade 25 is affixed using in-hex machine screws 67. Above the housing 53, the connecting rod 55 extends via a connecting arm 69 to a pivot point provided at an in-hex machine screw mounting point 71 attaching to a strip of spring steel 73 which is bolted to the cutting tool 11 inside the transmission case. Similarly, the connecting rod 57 has a bevelled portion on its outside, below the housing 53, to which blade 25 is affixed using in-hex machine screws 75. Above the housing 53, the connecting rod 57 extends via a connecting arm 69 to a pivot point provided at an in-hex machine screw mounting point 77 attaching to a strip of spring steel 79 which is also bolted to the cutting tool 11 inside the transmission case.

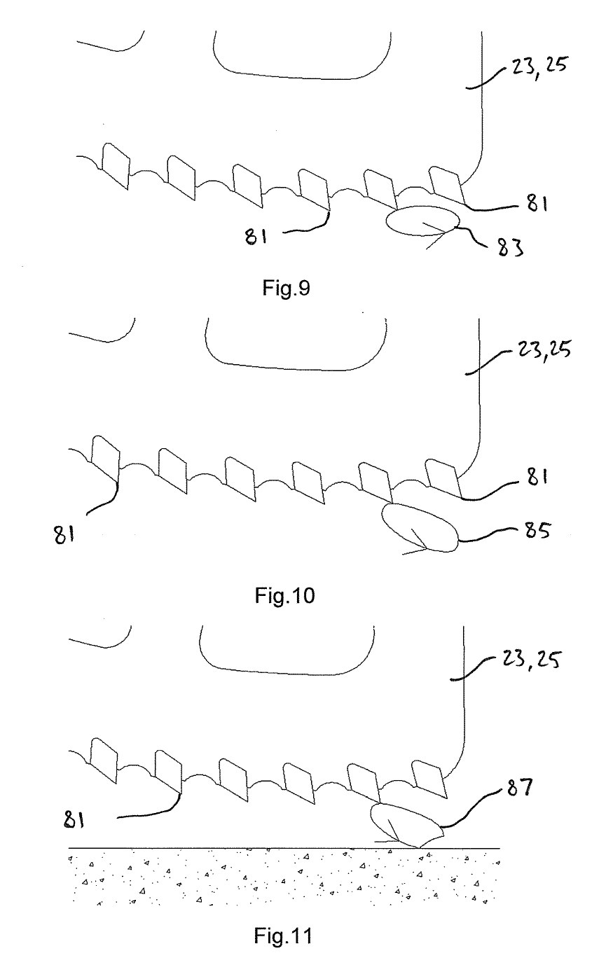

The arrangement of the pivot point 71 operates to fix the movement of the connecting rod 55 relative to the pivot points. With the strip of spring steel 73 being inextendible and incompressible, allowing only vertical movement in the direction extending between the central axis of the bearing surface 45 of the cam follower 41 and the pivot point 71, the blade cutting tips 81 follow an elliptical path 83, which at low motor speed is as shown in FIG. 9.

The same applies for the arrangement of the pivot point 77 operating to fix the movement of the connecting rod 57 relative to the pivot points, with the strip of spring steel 79 allowing only vertical movement in the direction extending between the central axis of the bearing surface 47 of the cam follower 43, causing the blade cutting tips 81 to follow an elliptical path 83, which at low motor speed is as shown in FIG. 9. The strips of spring steel 73 and 79 each have an aperture 84 to bolt the strips of spring steel 73 and 79 to the inside of the transmission case 19.

The assembly of cam follower 41 co-operating with connecting rod 55, and sprung with springs 59 and 61 form a biased slide/spring suspension coupling with bidirectional bias between the connecting rod 55 and blade 25. Similarly, the assembly of cam follower 43 co-operating with connecting rod 57, and sprung with springs 59 and 61 form a biased slide/spring suspension coupling with bidirectional bias between the connecting rod 57 and blade 23.

The enhancement provided by the embodiment is that the cam now connects via the biased slide/spring suspension coupling that allows the blade/conrod assembly to move a defined distance in the same plane (vertical) as the pivot point, while not allowing any movement in the (horizontal) plane normal to the direction of movement allowed at the pivot point. In other words, where the cam is connected to the conrod/blade assembly, it is sprung so that inertia produced by the cam allows the conrod/blade assembly to move beyond the orbit in the vertical direction but is confined to the extent of the orbit in the horizontal plane.

Referring to FIG. 9, the elliptical path 83 of the blade tooth orbit is shown at low motor speed. Due to the stiffness of the springs 59 and 61, this path is more or less identical to the path of the applicant's prior art cutting tool, the original Allsaw.

However as speed increases when free running, the elliptical path of the blade tooth orbit changes under the effect of the biased sliding/spring suspension mechanism, causing the short axis of the ellipse to increase in length, allowing the teeth to move further outward in the vertical direction, and the shape of the ellipsis becomes skewed, but the elliptical path is constrained in the horizontal (long axis) direction. At maximum free running speed the elliptical path 85 will become more like that shown in FIG. 10. This deviation from the elliptical path shown in FIG. 10 is facilitated by a combination of the inertia of the con rod assembly and robust springs which at low speeds would return the path of the teeth to the original elliptical path 93 shown in FIG. 9. FIG. 9 represents the inner limit of the elliptical tooth path 83 and FIG. 10 represents the outer limit of any elliptical tooth path 85.

If the teeth were brought into contact with any material while operating at full speed, the teeth would either penetrate the material or be allowed to deviate from its original path if the material is too hard to penetrate. The result is that when striking hard material, the reaction is very smooth. In such circumstances, the tooth path 87 has been observed and is shown in FIG. 11.

Further, when striking brittle material such as rock or concrete, the sudden change in tooth path releases energy into the material causing a chip to be produced. The high frequency of this chipping action results in a smooth cutting action even in the harder materials.

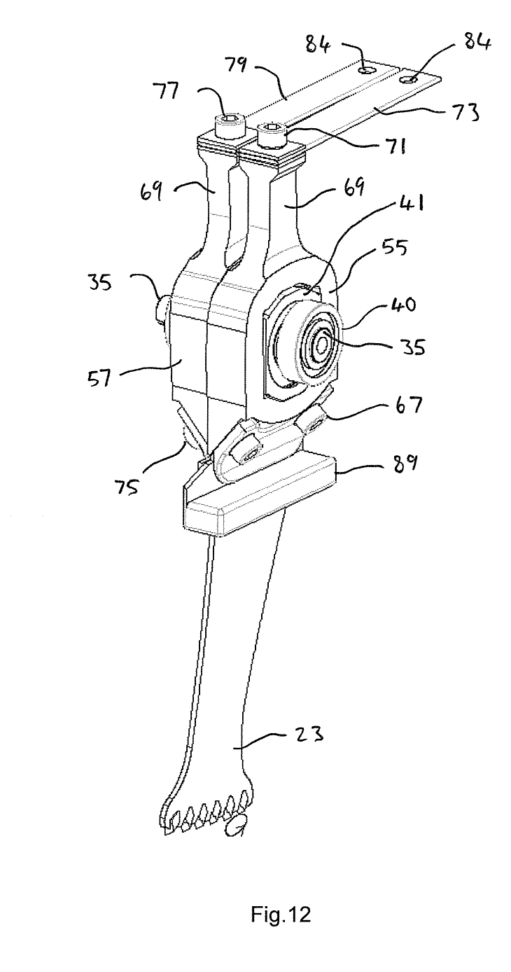

The second embodiment illustrated in FIG. 12 is identical to the first embodiment except that there is a single blade 23 which is a plunge cut style blade intended for uses such as cutting recesses in brickwork for installing electrical back boxes for switches and power points, or cutting away mortar in order to replace damaged bricks in brickwork. In this second embodiment, the driving mechanism 31 has a single output coupling formed by cam follower 43 contained in housing 53 in connecting rod 57. To counterbalance the weight of the offset journal 39 and its associated cam follower 43, offset journal 37 is fitted with a further output coupling formed by cam follower 41 contained in housing 53 in connecting rod 55 to which is fixed a counterweight 89, so the entire mechanism is balanced.

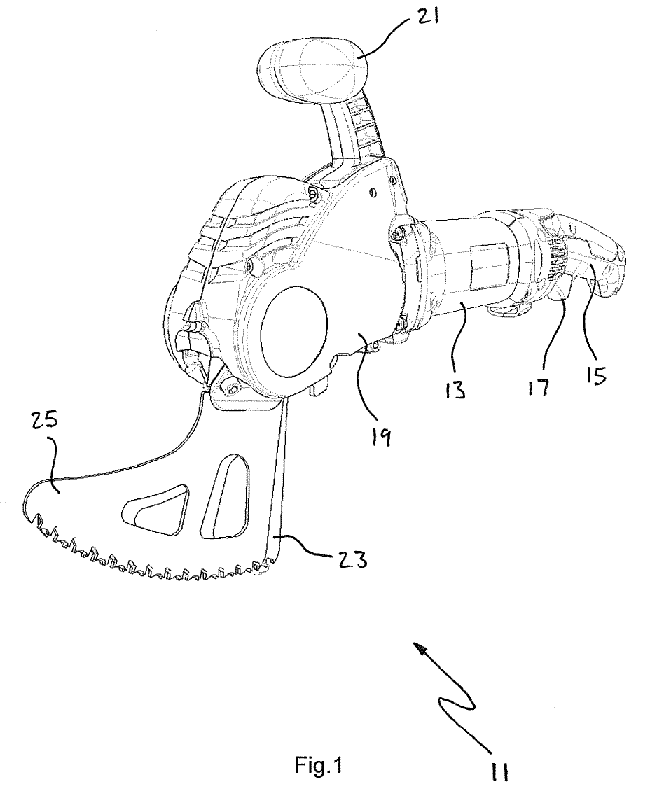

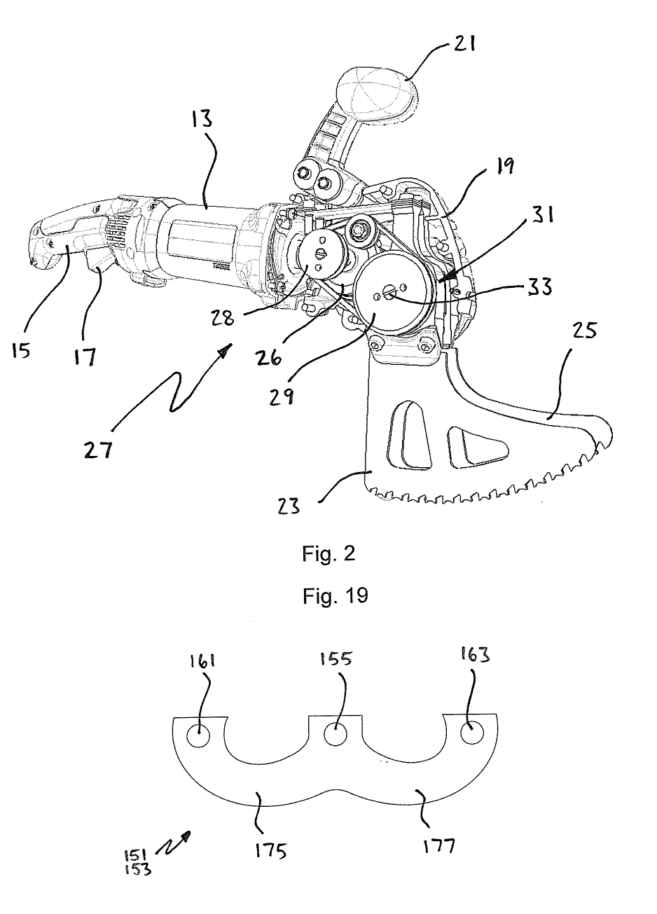

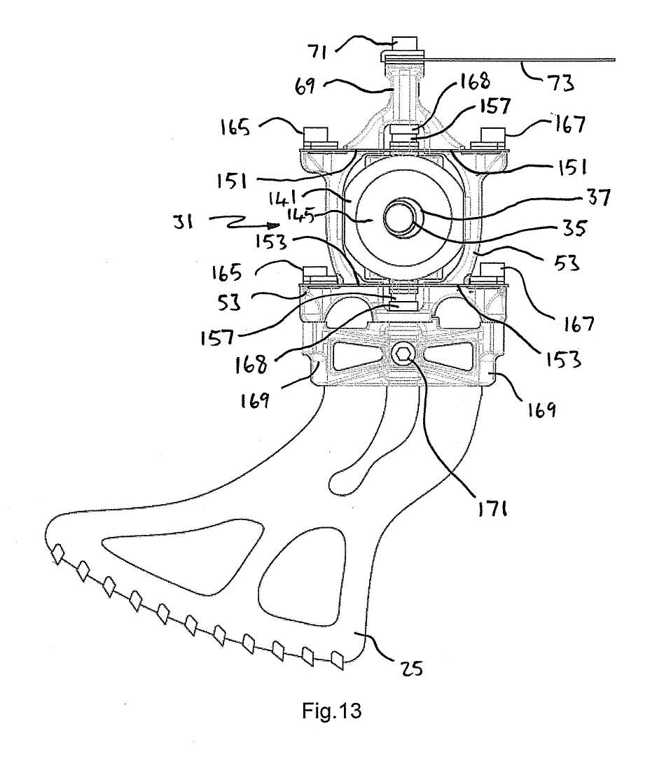

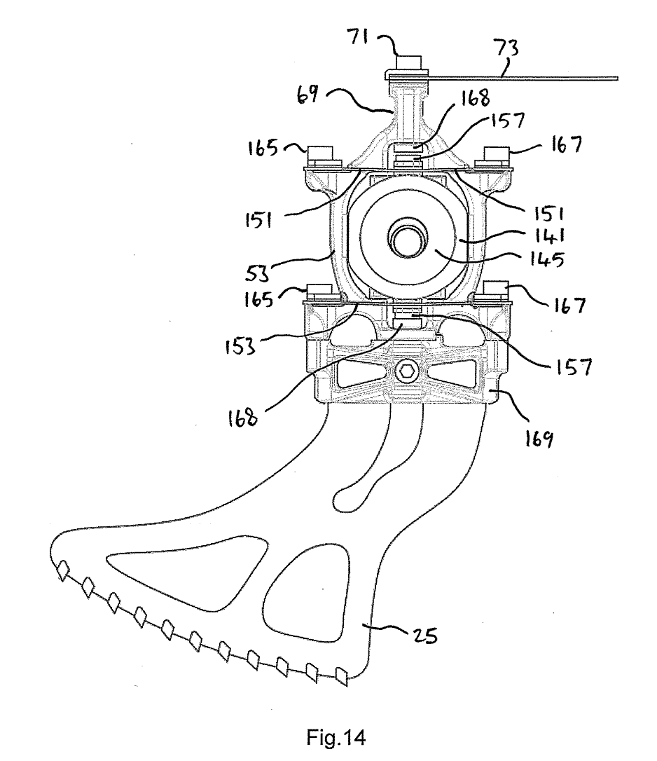

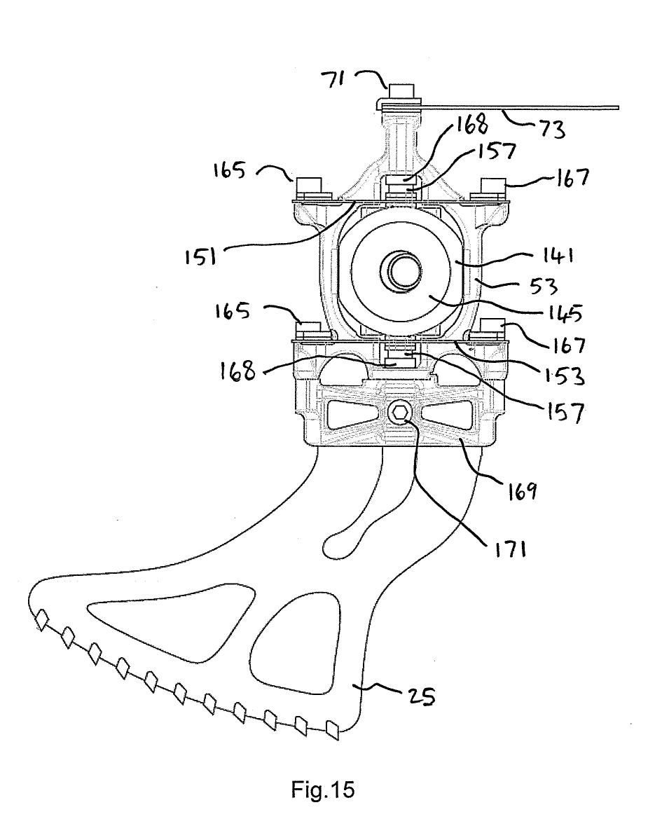

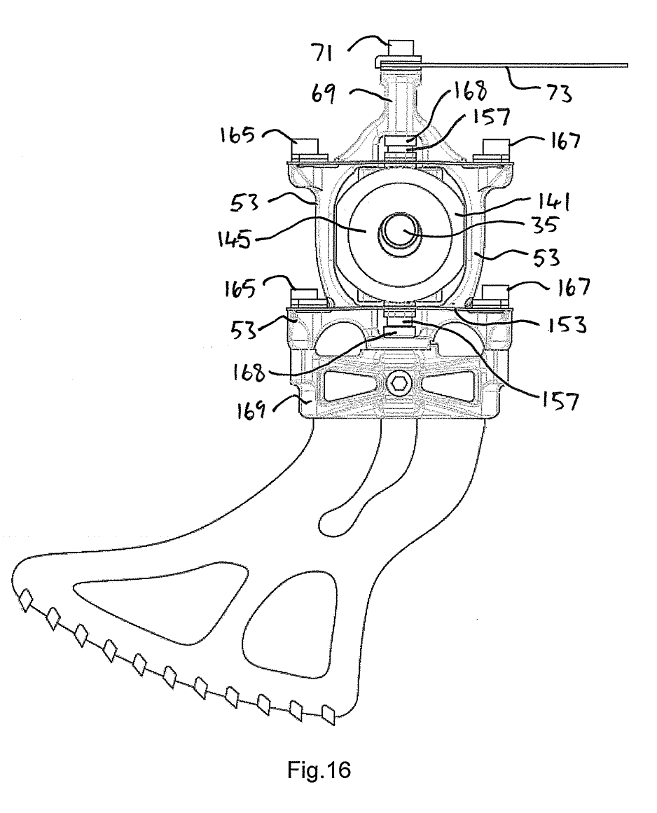

The third embodiment is illustrated in FIGS. 13 to 18. Where like parts have the same form and function as the first embodiment, the same numbering will be used. The third embodiment has the same features of the cutting tool 11 according to the first embodiment shown in FIGS. 1 and 2, having a body 13 housing an electric motor, a handgrip portion 15 at the rear of the body 13 incorporating a control switch 17 for controlling the electric motor, a transmission case 19 at the front of the body 13, a hand grip 21 atop the transmission case 19, and a pair of blades 23 and 25 arranged side by side, extending from underneath the transmission case 19.

As in the first embodiment, referring to FIG. 2, the transmission case 19 houses a bevel reduction-gear assembly partly shown as 26, to translate the axis of rotary motion of the electric motor, and a reduction belt drive 27 leading from a small pulley 28 to a large pulley 29, together the bevel reduction-gear assembly and reduction belt drive 27 reduce the angular velocity of the electric motor (and multiply the torque). The reduction belt drive 27 and associated pulleys 28 and 29 is a v-belt to allow slippage in the event of the blades 23 and 25 jamming. The small pulley 28 occludes the bevel gear on the shaft of the motor, the bevel gear on the shaft of the motor engaging with the larger bevel gear 26.

The large pulley 29 is directly connected to the driving mechanism 31 of the cutting tool 11, in effect forming part of the input coupling 33. The driving mechanism 31 has a crankshaft 35 having two journals 37 and 39 off-set from the central axis of the crankshaft by about 2 mm, and offset from each other by 180° relative to the central axis of the crankshaft 35.

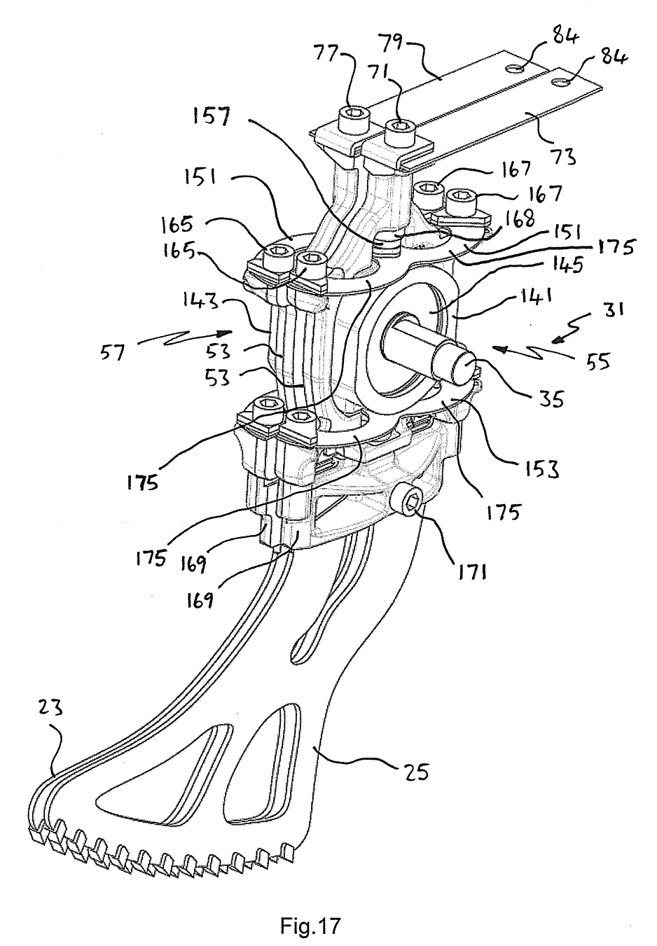

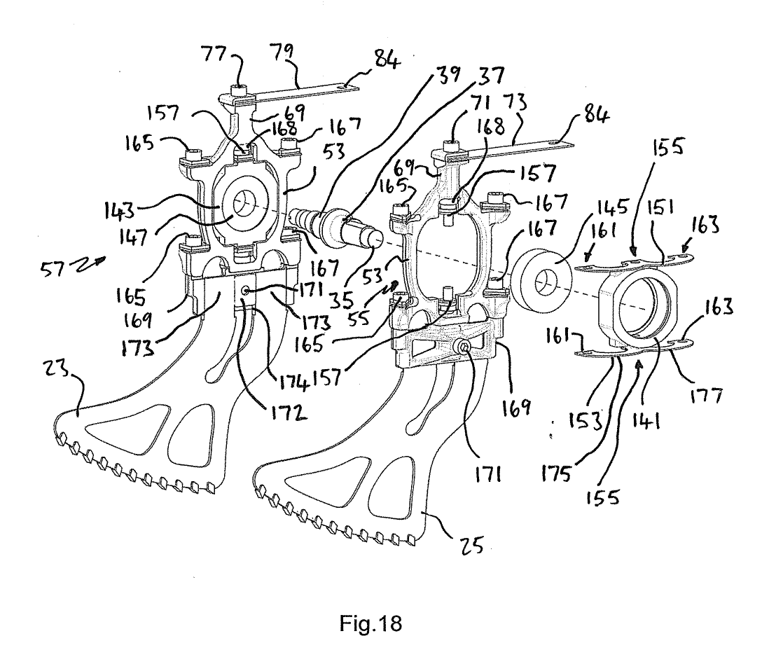

The driving mechanism 31 has two output couplings formed by cam followers 141 and 143 having cylindrical bearings 145 and 147 respectively that co-operate with journals 37 and 39 respectively (see FIGS. 17 and 18). It should be noted that in the part views shown in FIGS. 13 to 17, the journal 37 is hidden behind the left hand side blade and mechanism assembly, but can be seen in FIG. 18. The cam followers 141 and 143 are each suspended from two flat springs 151 and 153, one 151 located at the top of each cam follower 141 and 143 and the other 153 located at the bottom of each cam follower 141 and 143.

The flat springs 151 and 153 are each secured through an aperture 155 located at a central location to their cam follower 141 143 by an in-hex machine screw 157 with a locking washer to prevent shaking loose during operation. The flat springs 151 and 153 are also each secured through apertures 161 and 163 located equidistant from the aperture 155 at either end of the flat springs 151 and 153, by in-hex machine screws 165 and 167 with locking washers, to a body in the form of a housing 53.

The cam followers 141 and 143 and their respective housings 53 are suspended relative to each other, and together form a biased spring suspension coupling, with the springs 151 and 153 both suspending these parts relative to each other and biasing them toward a central position which the housings 53 may oscillate either side of when the crankshaft 35 is rotated under operation. This arrangement differs from the first embodiment in that journal surfaces are not required for controlling the relative movement of the cam followers 141 and 143 and their respective housings 53.

Pieces of 2 mm thick polyurethane foam rubber disc 168 located above the top screw 157 and below the bottom screw 157 cushion any impact of the screws 157 with proximal portions of the castings that form the housings 53. These cushion any impact that otherwise might occur between the screws 157 and the housings 53 in the event that the coupling undergoes an excessive excursion.

Each housing 53 has a mounting portion 169 located underneath, also secured by screws 165 and 167, each mounting portion 169 having a blade 23 or 25 secured thereto by an in-hex machine screw 171 which secures into a threaded aperture in a rectangular plate member 172.

The rectangular plate member 172 is formed with sloping vertical edges. The blade is formed with a bifurcation at its top, leading to mounting fingers 173 which have opposed bevelled inner edges 174. The opposed bevelled edges 174 of the blade match the sloping vertical edges of the rectangular plate member 172 in an interference fit when the in-hex machine screw 171 is tightened in the rectangular plate member 172, to securely mount the blade. The mounting portions 169 are each formed with a machined recess to match the blade shape and securely flush mount the blade, providing security against the blade undergoing in-line torsion during operation. The arrangement of the in-hex machine screw 171, the rectangular plate member 172, and the mounting portion 169, co-operating with the fingers 173 of the blade provides a quick release mechanism allowing simple blade changing with the release of the single screw 171.

The housing 53 contains cam follower 141, restrained by their springs 151 and 153 for linear vertical movement, and the other housing 53 contains cam follower 143, restrained by their springs 151 and 153 for linear vertical movement. The assembly of cam follower 141 co-operating with journal 37 forms one output coupling, while the assembly of cam follower 143 co-operating with journal 39 forms another output coupling.

Above each housing 53, a connecting arm 69 extends to a pivot point provided at an in-hex machine screw mounting point 71. 77 attaching to a strip of spring steel 73, 79 which are bolted through apertures 84 to mounting points in the cutting tool 11 inside the transmission case.

Each connecting arm 69, body 53 and mounting portion 169 forms a connecting rod 55, 57 extending between their respective pivot points which operate to fix the movements of the connecting rods 55, 57 relative to their respective pivot points. With the strips of spring steel 73, 79 being inextendible and incompressible, allowing only vertical movement in the direction extending between the central axes of the journals 37, 39 and the pivot points of the respective assemblies, the blade cutting tips 81 of each blade follow an elliptical path 83, but 180° out of phase with each other. This elliptical path, at low motor speed, is as shown in FIG. 9.

The flat springs 151 and 153 have their apertures 161, 155 and 163 located in-line and spaced evenly apart. The body 175 of the flat springs 151, 153 that extends between adjacent apertures 161 and 155 and the body 177 of the flat springs 151, 153 that extends between adjacent apertures 163 and 155, both deviate from the straight line extending between the apertures 161, 155 and 163 to take on planar curved forms in their configuration. This is largely to provide clearance from the housing 53, but gives rise to an additional benefit in that when the flat springs 151 and 153 undergo deflection, there is a combination of effects that enhance their operation compared with a linear flat spring. These effects are greater effective length of the distances between adjacent apertures, torsion occurring between adjacent apertures 161 and 155 and between adjacent apertures 163 and 155 due to the curvature in the body portions 175 and 177, and tension between adjacent apertures 161 and 155 and between adjacent apertures 163 and 155 on account of the distance between the adjacent apertures increasing. It should be understood that the deflection of the bodies relative to the cam followers as limited by the flat springs 151 and 153 is only about 1 mm in total.

In the tool according to all of the embodiments, the flat springs 73, 79, 151 and 153 are manufactured from 1.2 mm thick spring steel. The spring steel sheet from which the flat springs are manufactured may be between 1 mm and 2 mm, or can be thicker longer. The springs 60 and 61 are wound from 1.5 mm diameter spring steel wire. The crankshaft 35 and cam followers 141 and 143 are formed from 4140 steel alloy, while the remaining parts are cast from aluminium alloy.

It should be noted that for this particular type of cutting saw as described and illustrated in the embodiments, the amount of travel in the vertical (short axis) needs to be less that the orbit of the cam. In the case of the embodiment, the cam has a 2 mm offset creating a 4 mm orbit. Having less than 4 mm of travel causes the vertical (short axis) motion to synchronise with the orbit of the cam. If the sprung conrod assembly were allowed to travel further than the orbit of the cam, it will seek its natural frequency independent of the cam resulting in an uncontrolled or random tooth path which has proven to be not helpful to the cutting action.

One other aspect that needs to be understood is the contribution that the selection of the springs controlling the vertical or short axis makes to the cutting action.

When operated at running speed, the inertia of the conrod/blade assembly needs to be countered by springs of sufficient strength that they are fully compressed at both the top and bottom of the short axis. Ideally they fully compress but exactly resist the conrod assembly from slamming into the vertical (short axis) limits top and bottom. It has been unexpectedly found that the lag between the inertia of the conrod assembly and the rotation of the cam results in the spring releasing its energy as the spring expands thus adding extra velocity to the downward thrust of the blade, further improving the cutting efficiency of the action.

While the above described embodiment describes using two blades side by side to balance the action for heavy blades. In the prior art devices produced by the inventor and applicant, it was not possible to use a single blade because the reaction from a single blade is too violent to effect a suitable cutting action. With the new invention however, the spring suspension of the con rod/blade assembly allows a very smooth cutting action as the con rod/blade assembly is allowed to deviate from the elliptical path without forcing a reaction through the whole machine. It is thus now possible and often desirable to use just a single blade to effect a narrower cut.

The invention significantly improves the cutting action of this style of oscillatory power tool, showing a superior ability to cut harder materials such as stone and concrete. The biased spring suspension mechanism provides a smoother cutting action with less impact reaction through the tool, and provides better control. In addition the invention opens up the possibility of making a tool having the same cutting action but using a single blade only as opposed to two juxtaposed blades.

It should be appreciated that the scope of the invention is not limited to the specific embodiment disclosed herein, and that changes may be made without departing from the spirit and scope of the invention.

1. A cutting tool mechanism for a cutting tool having a blade; in said cutting tool, said blade being driven by a driving mechanism with an input coupling for transmission of rotary motion from a motor, and an output coupling to transmit resultant orbital, oscillatory or impact motion to said blade, wherein said cutting tool mechanism comprises located between said output coupling and said blade, a coupling selected from a slide coupling and/or a spring suspension coupling through which the motion of said output coupling is transmitted to said blade.

2. The cutting tool mechanism of claim 1, wherein the coupling has travel extending in a direction toward said blade.

3. The cutting tool mechanism of claim 1, wherein the coupling has linear travel extending in a direction toward said blade.

4. The cutting tool mechanism of claim 1, wherein the coupling is biased to a position along its travel.

5. The cutting tool mechanism of claim 4, wherein said coupling has a bidirectional bias to suspend the blade from the output coupling in a central position.

6. The cutting tool mechanism of claim 1, wherein said coupling is a spring biased sliding coupling.

7. The cutting tool mechanism of claim 1, wherein said output coupling is connected to said input coupling by a crankshaft and wherein said coupling comprises said output coupling mounted for linear travel relative to a body, said output coupling being biased by at least one spring, and having a bearing for connecting to said crankshaft.

8. The cutting tool mechanism of claim 7, wherein said output coupling is contained within a housing in said body.

9. The cutting tool mechanism of claim 7, wherein said output coupling is biased by a spring located at each end to suspend said output coupling relative to said body, for substantially linear travel.

10. The cutting tool mechanism of claim 6, wherein any or each said spring comprises a flat spring which undergoes deflection from its rest position.

11. The cutting tool mechanism of claim 10, wherein said coupling comprises two flat springs, one located near or at opposite ends of said output coupling.

12. The cutting tool mechanism of claim 10, wherein the flat springs are secured at three locations therealong, being toward either end to secure to said body and being centrally located to secure to said output coupling.

13. The cutting tool mechanism of claim 12, wherein the three locations are located substantially in-line.

14. The cutting tool mechanism of claim 13, wherein the flat springs have a flat body that between adjacent locations, deviates away from the line intersecting the three locations.

15. The cutting tool mechanism of claim 14, wherein between adjacent locations, the flat body deviates away from the line intersecting the three locations in a smoothly curving configuration.

16. The cutting tool mechanism of claim 1, wherein the blade is mounted to a mounting portion extending from one end of the coupling, and the other end of the coupling extends to a pivot point to restrain movement from the output coupling.

17. The cutting tool mechanism of claim 16, wherein the pivot point is provided by a resilient mount that allows motion in the substantial direction extending between the output coupling and the pivot point, while restraining motion in any other direction.

18. The cutting tool mechanism of claim 17, wherein the resilient mount is formed by a strip of spring steel that is flexible in the direction of movement of the coupling, but resists movement in other directions, and is inextendable under tension or compression.

19. A cutting tool incorporating the cutting tool mechanism of claim 1.

20. A cutting tool incorporating two cutting tool mechanisms as claimed in claim 16, located side by side, wherein the input couplings of both said mechanisms comprise a common crankshaft having journals each connected for rotation with a cam follower to form the output coupling of each said cutting tool mechanism, where the journals of said crankshaft are out of phase.
